(19) United States
(12) Patent Application Publication
(10) Pub. No.: US 2016/0137016 A1
(43) Pub. Date: May 19, 2016

(54) INTERNAL COMBUSTION ENGINE HAVING A TWO STAGE TURBOCHARGER

(71) Applicant: GM GLOBAL TECHNOLOGY OPERATIONS LLC, Detroit, MI (US)

(72) Inventors: Cesare Maria MEANO, Torino (IT); Vincenzo PETRONZI, Turin (IT)

(73) Assignee: GM GLOBAL TECHNOLOGY OPERATIONS LLC, Detroit, MI (US)

(21) Appl. No.: 14/940,258

(22) Filed: Nov. 13, 2015

(30) Foreign Application Priority Data
Nov. 13, 2014 (GB) 1420183.4

(51) Int. Cl. B60G 11/16; B62D 21/11; B60G 15/02

(52) U.S. Cl. CPC B60G 11/16; B60G 15/02; B62D 21/11; B60G 2204/124; B60G 2206/42

(57) ABSTRACT

In an internal combustion engine, a two stage turbocharger is disclosed including a low pressure turbine and the high pressure turbine are arranged in series. The high pressure turbine is connected to an exhaust manifold of the engine through a high pressure turbine inlet duct. The low pressure turbine is connected to the high pressure turbine through a low pressure turbine inlet duct and to the high pressure turbine inlet duct through a connecting channel. The two stage turbocharger is provided with a bypass system including a high pressure turbine valve arranged in the high pressure turbine inlet duct, and a low pressure turbine valve arranged in the connecting channel. An actuator is configured to operate the high pressure turbine valve and the low pressure turbine valve to alternatively close the high pressure turbine inlet duct or the connecting channel.

### CROSS-REFERENCE TO RELATED APPLICATION

This application claims priority to Great Britain Patent Application No. 1420183.4, filed Nov. 13, 2014, which is incorporated herein by reference in its entirety.

### TECHNICAL FIELD

The present disclosure pertains to an internal combustion engine having a two stage turbocharger, and more particularly to an internal combustion engine having a two stage turbocharger provided with a bypass system for the high pressure turbine.

### BACKGROUND

Two stage turbochargers for internal combustion engines typically include a High Pressure (HP) turbocharger and a Low Pressure (LP) turbocharger arranged in series. Each turbocharger in turn includes a compressor rotationally coupled to a turbine. This type of turbochargers is also known as serial sequential two stage turbochargers and are usually configured to operate both turbochargers at low/medium engine speeds and to operate the LP turbocharger only at high engine speed. In this second case, the HP turbocharger is bypassed. To minimize the number of actuators and simplify the layout, the bypass usually connects the points upstream and downstream of the HP turbine, without mechanically blocking its inlet.

When only the LP stage is operating, the system works as a parallel of two branches (the LP inlet channel and the HP turbine with its channels). Hence the exhaust gas can flow in both branches (the split depending on the ratio of the pressure drops across the two branches). However, it is important to guarantee that the maximum portion of gas flows through the LP section (ideally 100%, to minimize enthalpy losses). This can be realized by minimizing the pressure drop on the LP branch and, when still not enough, by covering the HP inlet channel to the gas flow. This may generally lead to lower turbocharger efficiency in two stage mode, which penalizes the low end and mid speed performance due to the resulting higher pumping losses.

The HP bypass valve can be actuated with the aid of a dedicated actuator which is driven by a circuit controlled by an Engine Control Unit (ECU). The ECU operates the HP bypass valve by opening it when a predefined engine condition, for example when a predefined engine speed is reached.

### SUMMARY

Accordingly, the present disclosure provides an internal combustion engine having a two stage turbocharger which optimizes both inlet ducts of the turbines without impairing the performance in the various operating modes of the two stage turbocharger.

An embodiment of the present disclosure provides an internal combustion engine having a two stage turbocharger including a high pressure turbine connected to an exhaust manifold of the engine through a high pressure turbine inlet duct and a low pressure turbine connected to the high pressure turbine through a low pressure turbine inlet duct and to the high pressure turbine inlet duct through a connecting channel. The low pressure turbine and the high pressure turbine are arranged in series. The two stage turbocharger is provided with a bypass system having a high pressure turbine valve arranged in the high pressure turbine inlet duct and configured to control the flow in the high pressure turbine inlet duct, and a low pressure turbine valve arranged in the connecting channel and configured to control the flow in the connecting channel. An actuator is configured to operate the high pressure turbine valve and the low pressure turbine valve to alternatively close the high pressure turbine inlet duct or the connecting channel.

An advantage of this embodiment is that, by closing alternatively one of the two accesses to the two turbines (i.e. the high pressure turbine and the low pressure turbine) it is possible to design both high and low turbine inlets for the best fluid dynamic performance. It should be noted that the expression “alternatively close the high pressure turbine inlet duct or the connecting channel” is used with the meaning that when the high pressure turbine valve is operated to close the high pressure turbine inlet duct the low pressure turbine valve is operated to open the connecting channel, and when the high pressure turbine valve is operated to open the high pressure turbine inlet duct the low pressure turbine valve is operated to close the connecting channel. In this way, no fluid dynamic preference for any of the inlet ducts of the turbines is needed anymore: both inlets can be designed to be as much permeable as possible. Likewise, maximum available enthalpy is given to the LP stage (low pressure turbine) in full power operation and to the HP stage (high pressure turbine) in maximum torque operation.

According to a further embodiment of the present disclosure, the actuator is configured to operate simultaneously the high pressure turbine valve and the low pressure turbine valve. An advantage of this embodiment is that it limits the mechanical complexity of the bypass system of the two stage turbocharger.

According to a further embodiment of the present disclosure, the high pressure turbine valve and the low pressure turbine valve are operated by a single actuator driven by an Electronic Control Unit of the engine. An advantage of this embodiment is that it simplifies the overall system by employing a single actuator for operating both valves.

According to another embodiment of the present disclosure, the actuator is driven as a function in dependence) of engine speed and engine load. More in detail, according to an embodiment of the present disclosure, the actuator is configured to open the high pressure turbine inlet duct and close the connecting channel, and vice versa (i.e. the actuator closes the high pressure turbine inlet duct and opens the connecting channel), as a function of engine speed and engine load. An advantage of this embodiment is that it allows a mechanical shutoff of the non-used turbine, allowing for the possibility of optimizing both the turbines inlet ducts and without impairing the performance in either power or low end ranges.

According to a further embodiment, the high pressure turbine valve includes a movable disc and the low pressure turbine valve includes a movable disc. The movable discs are connected to a common spindle. An advantage of this embodiment is that the common spindle layout allows a simple actuation of the valves, for example by the use of a single actuator.

More in detail, according to a further embodiment of the present disclosure, the high pressure turbine valve is provided with a first disc movable to close the high pressure turbine inlet duct, preferably in correspondence of a high pressure turbine inlet duct flange, and the low pressure turbine valve is provided with a disc movable to close the connecting channel, preferably in correspondence of a connecting channel flange. The flanges are aligned substantially on the same plane.

According to a possible embodiment, the disc of the high pressure turbine valve is arranged in correspondence of a high pressure turbine inlet flange and the disc of the low pressure turbine valve is arranged in correspondence of a connecting channel flange. More in detail, according to an embodiment of the present disclosure, a high pressure turbine inlet duct flange of the high pressure turbine inlet duct cooperates with the disc of the high pressure turbine valve to close the high pressure turbine inlet duct and a connecting channel flange of the connecting channel cooperates with the disc of the low pressure turbine valve to close the connecting channel. The flanges are aligned substantially on the same plane. In other words, the flange cooperating with the disc of the high pressure turbine valve is connected to, or provided in, the high pressure turbine inlet duct and the flange cooperating with the disc of the low pressure turbine valve is connected to, or provided in, the connecting channel. An advantage of this embodiment is that it allows the valves of the bypass system of the two stage turbocharger to be installed inside the exhaust manifold using a flange connection.

According to still another embodiment of the present disclosure, the discs are mounted on the spindle perpendicularly to one another so that a 90° rotation of the spindle causes the high pressure turbine inlet duct to be opened and the connecting channel to be closed, and vice versa. In other words, a 90° rotation of the spindle also causes the high pressure turbine inlet duct to be closed and the connecting channel to be opened. An advantage of this embodiment is that it allows the use a common spindle for both valves.

According to another embodiment of the present disclosure, the actuator is configured to operate by rotating the spindle from a position in which one disc closes the high pressure turbine inlet duct and the other disc opens the connecting channel to a position in which one disc opens the high pressure turbine inlet duct and the other disc closes the connecting channel and vice versa. In other words the actuator operates by rotating the spindle from a position in which one disc opens the high pressure turbine inlet duct and the other disc closes the connecting channel to a position in which one disc closes the high pressure turbine inlet duct and the other disc opens the connecting channel. An advantage of this embodiment is that it provides a mechanical solution for simultaneously operating the high pressure turbine valve and the low pressure turbine valve.

Still another aspect of the present disclosure provides a method of operating a two stage turbocharger for an internal combustion engine, according to the various aspects of the present disclosure. The two stage turbocharger includes a high pressure turbine connected to an exhaust manifold of the engine through a high pressure turbine inlet duct and a low pressure turbine connected to the high pressure turbine through a low pressure turbine inlet duct. The engine speed and an engine load are monitored. An actuator positions the high pressure turbine valve and the low pressure turbine valve for alternately closing the high pressure turbine inlet duct or the connecting channel as a function of the monitored engine speed and engine load.

According to another aspect of the present disclosure, the actuator operates simultaneously the high pressure turbine valve and the low pressure turbine valve. For example, the high pressure turbine inlet duct or the connecting channel is alternately closed by means of a 90° rotation of a spindle on which a disc suitable to close the high pressure turbine inlet duct and a disc suitable to close the connecting channel are mounted perpendicularly to one another.

The method according to one of its aspects can be carried out with the aid of a computer program including a program-code for carrying out the method described above, and in the form of computer program product including the computer program. The computer program product can be embodied as a control apparatus for an internal combustion engine, including an Electronic Control Unit (ECU), a data carrier associated to the ECU, and the computer program stored in a data carrier, so that the control apparatus defines the embodiments described in the same way as the method. In this case, when the control apparatus executes the computer program all the steps of the method described above are carried out.

### BRIEF DESCRIPTION OF THE DRAWINGS

The present disclosure will hereinafter be described in conjunction with the following drawing figures, wherein like numerals denote like elements.

FIG. 1 shows an automotive system;

FIG. 2 is a cross-section of an internal combustion engine belonging to the automotive system of FIG. 1;

FIG. 3 is a schematic illustration of a two stage turbocharger for an internal combustion engine provided with a bypass system;

FIG. 4 is schematic illustration of an implementation of a bypass system of the two stage turbocharger;

FIG. 5 is schematic illustration of a bypass valve element in a first operating position; and

FIG. 6 is schematic illustration of a bypass valve element, shown in FIG. 5, in a second operating position.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

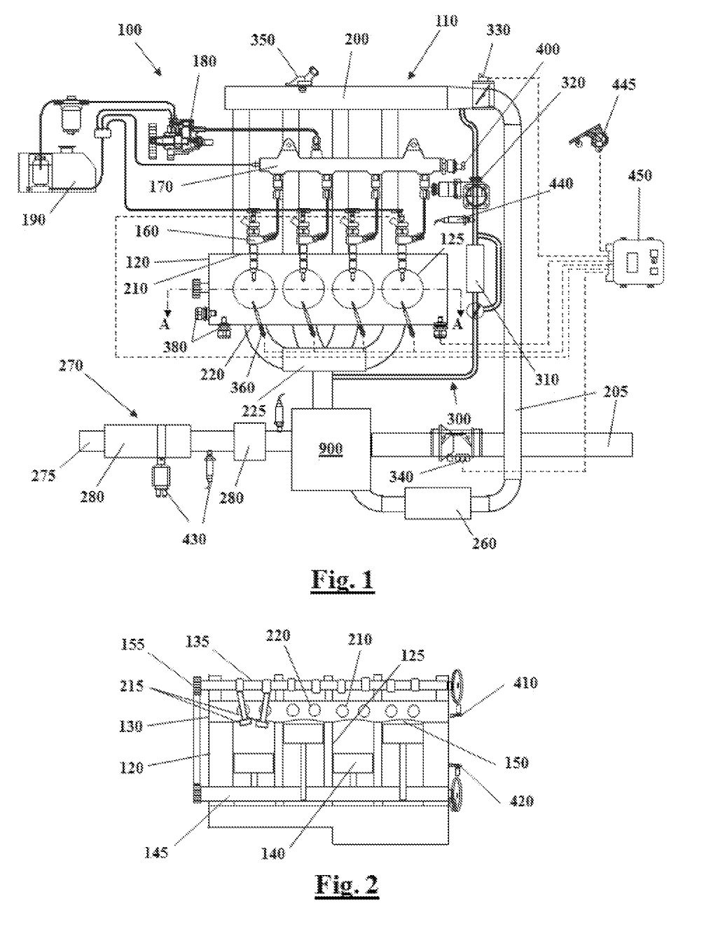

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140, The fuel is provided by at least one fuel injector 160 and the air through at least one intake port 210. The fuel is provided at high pressure to the fuel injector 160 from a fuel rail 170 in fluid communication with a high pressure fuel pump 180 that increases the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200.

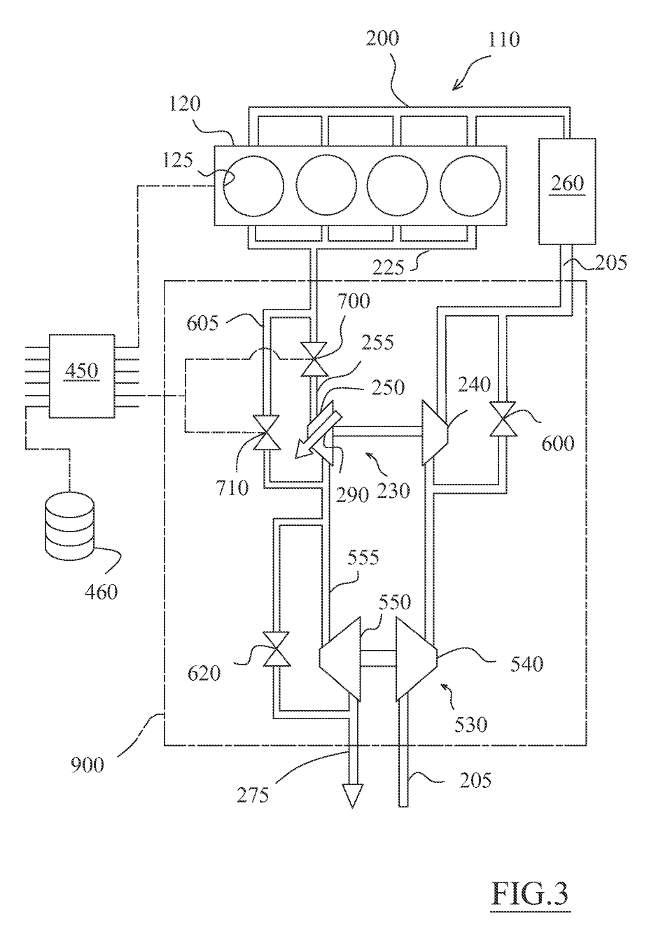

In still other embodiments, a forced air system may be provided, the forced air system including a two stage turbocharger 900 described in greater detail hereinafter in connection with FIG. 3.

The exhaust gases of the engine are directed into an exhaust system 270. The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NO traps, hydrocarbon absorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, a Variable Geometry Turbine (VGT) actuator 290 (FIG. 3), and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system, or data carrier 460, and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carry out the steps of such methods and control the ICE 110.

The program stored in the memory system is transmitted from outside via a cable or in a wireless fashion. Outside the automotive system 100 it is normally visible as a computer program product, which is also called computer readable medium or machine readable medium in the art, and which should be understood to be a computer program code residing on a carrier, said carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code, Carrying such computer program code can be achieved by modulating the signal by a conventional modulation technique such as QPSK for digital data, such that binary data representing said computer program code is impressed on the transitory electromagnetic signal. Such signals are e.g. made use of when transmitting computer program code in a wireless fashion via a Wi-Fi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an onboard computer, or any processing module that might be deployed in the vehicle.

Referring now to FIG. 3, the forced air system for the engine 110, including the two stage turbocharger 900, is described in more detail.

Such system includes a two stage turbocharger for the internal combustion engine 110, preferably a serial sequential two stage turbocharger, the two stage turbocharger 900 including a high pressure turbocharger 230, having a high pressure compressor 240 rotationally coupled to a high pressure turbine 250, the high pressure turbine 250 being connected upstream to a high pressure turbine inlet duct 255 stemming from the exhaust manifold 225 and downstream to a low pressure turbocharger 530.

The low pressure turbocharger 530 is equipped with a low pressure compressor 540 rotationally coupled to a low pressure turbine 550, the low pressure turbine 550 receiving exhaust gas from both the high pressure turbine 250 through a low pressure turbine inlet duet 555 and the high pressure turbine inlet duct 255 through a connecting channel 605.

The high pressure turbine 250 rotates by receiving exhaust gases from the exhaust manifold 225 that directs exhaust gases from the exhaust ports 220 and through a series of vanes prior to expansion through the high pressure turbine 250. The exhaust gases exit the high pressure turbine 250 and are directed into the low pressure turbocharger 530.

In FIG. 3 a variable geometry turbine (VGT) with a VGT actuator 290 arranged to move the vanes to alter the flow of the exhaust gases through the high pressure turbine 250 is shown. In other embodiments, the turbocharger 230 may be fixed geometry and/or include a waste gate.

Furthermore, the exhaust gases exit the low pressure turbine 550 and are directed into the exhaust system 270.

The two stage turbocharger 900, in some embodiments, may also include a low pressure turbine bypass valve or waste gate 620, while the high pressure compressor 240 may also include a high pressure compressor bypass valve 600.

An intercooler 260 disposed in the duct 205 may reduce the temperature of the air exiting the high pressure compressor 240.

According to an embodiment of the present disclosure, the two stage turbocharger 900 includes a bypass system 800, the bypass system 800 being configured to alternatively close the high pressure turbine inlet duct 255 or the connecting channel 605. The bypass system 800 includes a high pressure turbine valve 700 and a low pressure turbine valve 710, both valves 700, 710 being configured to be operated at the same time by a command issued by the ECU 450. In other words, the valves 700, 710 are configured to alternatively close the high pressure turbine inlet duct 255 or the connecting channel 605.

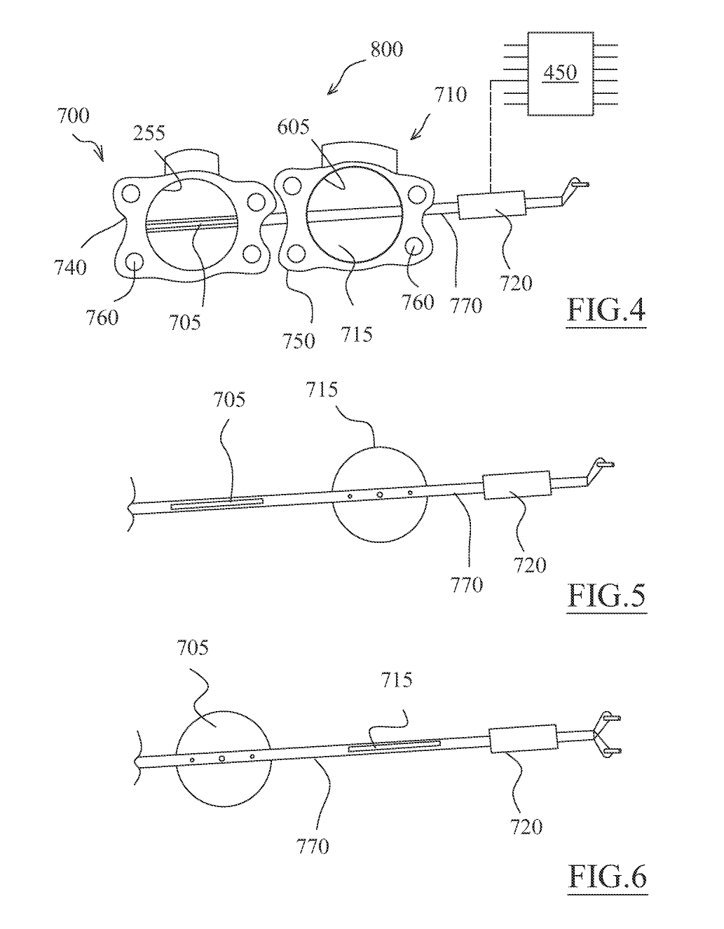

FIG. 4 is schematic illustration of a possible implementation of a bypass system 800 of the two stage turbocharger 900 of an internal combustion engine 110, according to an embodiment of the present disclosure. A spindle 770 provided with a disc 705 for the high pressure turbine valve 700 and with a disc 715 for the low pressure turbine valve 710 is provided. An actuator 720 is provided to actuate the spindle 770, the actuator 720 being configured to be activated by a command issued from the ECU 450.

In the embodiment of FIG. 4, the bypass system 800 includes a high pressure turbine inlet duct flange 740 cooperating with the disc 705 of the high pressure turbine valve 700 to close the high pressure turbine inlet duct 255. The disc 705 of the high pressure turbine valve 700 is arranged in correspondence of high pressure turbine inlet duct flange 740. The bypass system 800 of the two stage turbocharger 900 further includes a connecting channel flange 750 cooperating with the disc 715 of the low pressure turbine valve 710 to close the connecting channel 605. The disc 715 of the low pressure turbine valve 710 is arranged in correspondence of the connecting channel flange 750. The flanges 740, 750 are aligned substantially on the same plane.

More in detail, the flange 740 is connected to, or directly provided in, the high pressure turbine inlet duct 255 and the flange 750 is connected to, or directly provided in, the connecting channel 605. The flanges 740 and 750 are disposed in such a way that the lay on the same plane. Both flanges 740, 750 have respective holes 760 for fixing to the exhaust gas circuit.

The configuration of the flanges and of the discs 705, 715 allows for the use of a single spindle 770.

Moreover, e ECU 450 is configured to monitor the engine speed E_{speed}, the engine load E_{load} and, eventually, other engine parameters as known in the art. More in particular, in the exemplary embodiment of FIGS. 4-6, the high pressure turbine valve 700 and the low pressure turbine valve 710 include two butterfly valves, having discs 705, 715 respectively closing or opening the high pressure turbine inlet duct 255 and the connecting channel 605.

In other words, the bypass system 800 includes a high pressure turbine valve 700 provided in the high pressure turbine inlet duct 255 and a low pressure turbine valve 710 provided in the connecting channel 605 and an actuator 720 operating the high pressure turbine valve 700 and the low pressure turbine valve 710 to alternatively close the high pressure turbine inlet duct 255 or the connecting channel 605.

According to an embodiment of the present disclosure, the actuator 720 operates simultaneously the high pressure turbine valve 700 and the low pressure turbine valve 710. As seen in FIGS. 5-6, the discs 705, 715 are fixed on the same spindle 770, and are perpendicular to one another so that a 90° rotation of the spindle 770, following a command of the actuator 720, causes the high pressure turbine inlet duct 255 to be opened and the connecting channel 605 to be closed. A 90° rotation of the spindle 770 in the opposite direction causes the high pressure turbine inlet duct 255, previously opened, to be closed and the connecting channel 605, previously closed, to be opened. According to an alternative embodiment of the present disclosure both valves 700 and 710 can be realized to form a single valve body.

In operation, when the engine 110 is operating at low or medium speeds or, for example, when monitored engine speed E_{speed} and engine load E_{load} have suitable values to allow two stage operation of the turbocharger 900, the high pressure turbine 240 is operated and the low pressure turbine 540 receives gases through the low pressure turbine inlet duct 555 downstream the high pressure turbine 250.

In this case, the spindle 770 is in a position in which the disc 705 disc of the high pressure turbine valve opens the high pressure turbine inlet duct 255 and the other disc 715 of the low pressure turbine valve closes the connecting channel 605 (FIG. 4).

When the engine 110 is operating at high speed, or for example when the engine speed E_{speed} and engine load E_{load} have suitable values to allow single stage operation of the turbocharger 900, the high pressure turbine 240 is bypassed and the low pressure turbine 540 is operated.

This effect may be obtained by activating the actuator 720 by means of a respective command issued by the ECU 450 sensing, for example, an increased engine speed, or in general conditions that require a single stage operation of the turbocharger. This command rotates the spindle 770 for a 90° rotation from the position in which the disc 705 of the high pressure turbine valve opens the high pressure turbine inlet duct 255 and the other disc 715 of the low pressure turbine valve closes the connecting channel 605, to a position in which the disc 705 of the high pressure turbine valve closes the high pressure turbine inlet duct 255 and the disc 715 of the low pressure turbine valve opens the connecting channel 605.

If the engine 110 reverts back to operating at low or medium speeds, or to conditions that require a two stage operation of the turbocharger, the high pressure turbine 240 is operated again and the low pressure turbine 540 is operated as before described.

In this case, as soon as the engine speed E_{speed} drops below a predefined value E_{speedTH}, or engine speed E_{speed} and engine load E_{load} revert to values that allow two stage operation of the turbocharger, the ECU 450 issues a command to the actuator 720 to rotate the spindle 770 for a 90° rotation in the opposite direction, in such a way that the spindle 770 passes from the position in which the disc 705 of the high pressure turbine valve closes the high pressure turbine inlet duct 255 and the disc 715 of the low pressure turbine valve opens the connecting channel 605, to the position in which the disc 705 opens the high pressure turbine inlet duct 255 and the other disc 715 closes the connecting channel 605.

Monitoring an engine speed E_{speed} and an engine load E_{load} by the ECU 450 therefore allows for alternatively closing the high pressure turbine inlet duct 255 or the connecting channel 605 as a function of the monitored engine speed E_{speed} and engine load E_{load}.

As described above, the step of alternatively closing the high pressure turbine inlet duct 255 or the connecting channel 605 is performed by means of a 90° rotation of a spindle 770 on which a disc 705 of the high pressure turbine valve suitable to close the high pressure turbine inlet duct 255 and a disc 715 of the low pressure turbine valve suitable to close the connecting channel 605 are mounted perpendicularly to one another.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-14. (canceled)

15. A support structure component for connecting a spring strut to a vehicle body comprising:
a connection section having configured to connect to a vehicle body, the connection section have a flange section formed on a lower portion of the connection section; and
a spring strut mount attached to the flange section and configured to mount the spring strut.

16. The support structure component according to claim 15, wherein the flange section configured to connect with the spring strut mount in at least one of a materially joined manner, a positively joined manner and a non-positively joined manner.

17. The support structure component according to claim 15, further comprising a connection member provided on the connection section in the region of the flange section, and a counter-connection member provided on the spring strut member and in operational connection with the connection member.

18. The support structure component according to claim 15, wherein the support structure component comprises a shell structure having at least two shells.

19. The support structure component according to claim 18, wherein a first shell forms a wheel housing section and a second shell forms a reinforcing structure.

20. The support structure component according to claim 18, wherein the at least two shells are connected together to form a hollow profile having a longitudinal extension which extends transversely to the longitudinal extension of the connection section.

21. The support structure component according to claim 20, wherein the at least two shells are connected together to form at least two hollow profiles, wherein between the two hollow profiles the support structure component has a passage opening configured to receive an end of a spring strut.

22. The support structure component according to claim 20, wherein the connection member is arranged in the region of the hollow profile and a hollow space of the hollow profile is bridged by a sleeve element, which serves for receiving a counter-connection member that can be brought into operational connection with the connection member.

23. A spring strut mount for attaching to the flange section of a support structure component according to claim 15 with a basic body on which a spring strut for a motor vehicle is mounted.

24. The spring strut mount according to claim 23, wherein the basic body comprises a dome-like shape having at least one connection section at an open end of the basic body projecting towards the outside, so that the basic body can be introduced through a passage opening in a support structure component and the connection section serves as a stop against the support structure component.

25. An assembly unit with a spring strut mount according to claim 23 and a spring strut comprising a shock absorber element and a spring element, wherein the shock absorber element is mounted on the spring strut mount and the spring element supports itself against the spring strut mount.

26. A vehicle body comprising a side member, a longitudinal structure substantially running in longitudinal direction of the side member, and a support structure component according to claim 15 arranged therebetween and attached with a connection section on the side member and with another connection section on the longitudinal structure.

27. The vehicle body according to claim 26, wherein the support structure component is attached on the vehicle body in such a manner that an assembly unit is brought into attaching position against the support structure component from the bottom and can be attached to the support structure component from the bottom.

28. A method for mounting a spring strut on a vehicle body provided with a support structure component according to claim 15, wherein a spring strut is first mounted on the spring strut mount, and subsequently the spring strut mount together with the spring strut is brought into attaching position against the support structure component from the bottom and then attached to the support structure component from the bottom.
